(19) United States
(12) Patent Application Publication
(10) Pub. No.: US 2007/0027675 A1
(43) Pub. Date: Feb. 1, 2007

(54) Spectrum analyzer control in an oscilloscope

(75) Inventor: Michael G. Hertz, Washington Township, MI (US)

Correspondence Address: LECROY CORPORATION, 700 CHESTNUT RIDGE ROAD, CHESTNUT RIDGE, NY, 10977, US

(73) Assignee: LeCroy Corporation, Chestnut Ridge, NY (US)

(21) Appl. No.: 11/189,352

(22) Filed: Jul. 26, 2005

(51) Int. Cl. G10L 19/00

(52) U.S. Cl. 704/200.1

(57) ABSTRACT

A time domain measurement instrument and method are provided. The instrument comprises an acquisition circuit for acquiring a signal in a time domain and a processor for performing a Fast Fourier Transform (FFT) processing on the acquired signal to generate an FFT of the acquired signal. A frequency domain analysis tool is also provided for analyzing and manipulating the FFT, wherein the frequency domain analysis tool instructs the processor to automatically determine the frequency of a peak amplitude of the FFT, and to determine the amplitude at the determined peak frequency.

### BACKGROUND OF THE INVENTION

The present invention relates generally to time domain measurement instruments, such as an oscilloscope, and more particularly to such an instrument that employs a frequency domain analysis feature.

Spectrum analyzers are well known devices that receive an input signal, and sample and display the signal in the frequency domain. While dedicated Spectrum Analyzers have been available from any number of sources, they can often be expensive, and require a user to buy such a unit in addition to other test equipment. However, with these drawbacks, Spectrum Analyzers provide a great level of control of viewing the frequency domain signal.

Oscilloscopes and other time domain analysis measurement instruments are used generally to view an input signal in the time domain. Various functions and measurements may be performed on the time domain displayed signal. Additionally, a number of oscilloscopes allow for the viewing of a signal as if it were on a Spectrum Analyzer that is in the frequency domain. Rather than sampling the signal in the frequency domain as dedicated Spectrum Analyzers might do, such oscilloscopes typically perform a Fast Fourier Transform (FFT) on the time domain data to generate the frequency domain information. While the resulting signal can be displayed as a frequency domain signal, more advanced Spectrum Analyzer features have traditionally been lacking in such a setup, primarily because the oscilloscope has not been optimized to perform the Spectrum Analyzer functions.

An example of such an oscilloscope is described in U.S. Pat. No. 6,681,191 issued to Pickerd et al. While a frequency domain analysis system is described as being incorporated into a time domain measurement instrument, the features described that are associated with the frequency domain analysis system are primarily designed to provide integrated time base and frequency domain controls. For example, a user is able to control center frequency, frequency span, and resolution bandwidth by selecting an appropriate setting for each feature, using a front panel dial. Thus, the user is limited to manual control of the basic parameters of the frequency domain analysis system. However, such manual control, relying on the sight of a user, is often inaccurate.

Therefore, it would be beneficial to provide a control setup for a frequency domain analysis system implemented on a time domain measurement instrument that allowed for more precise measurement and automatic functioning.

### SUMMARY OF THE INVENTION

Therefore, in accordance with the invention, a more robust set of Spectrum Analyzer functions is provided in accordance with a frequency domain analysis system employed in accordance with a time domain measurement instrument. These features include a peak detect function that automatically determines the largest frequency peak of the FFT, and also includes functionality to make this automatically defined frequency the center frequency on the display. This automatically defined frequency can also be selectively placed at any location on the spectrum display. The defined frequency can also be defined by a user placing a cursor on a selected frequency of the FFT, and this frequency can be designated the center frequency, or can be placed at any other position along the spectrum. The response output can be rescaled both horizontally and vertically. Noise can be reduced and/or resolution increased in the acquisition and display.

The invention therefore allows for an enhanced set of analysis tools to be applied to a frequency domain analysis system residing in a time domain measurement instrument.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to affect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a screen shot depicting an oscilloscope screen before implementation of the invention;

FIG. 2 is a screen shot depicting selection of a peak search feature of the invention;

FIG. 3 is a screen shot depicting a marker to center frequency feature of the invention;

FIG. 4 is a screen shot depicting repositioning of a cursor while the center frequency remains the same;

FIG. 5 is a screen shot depicting the marker to center frequency of the invention utilizing the marked frequency of FIG. 4;

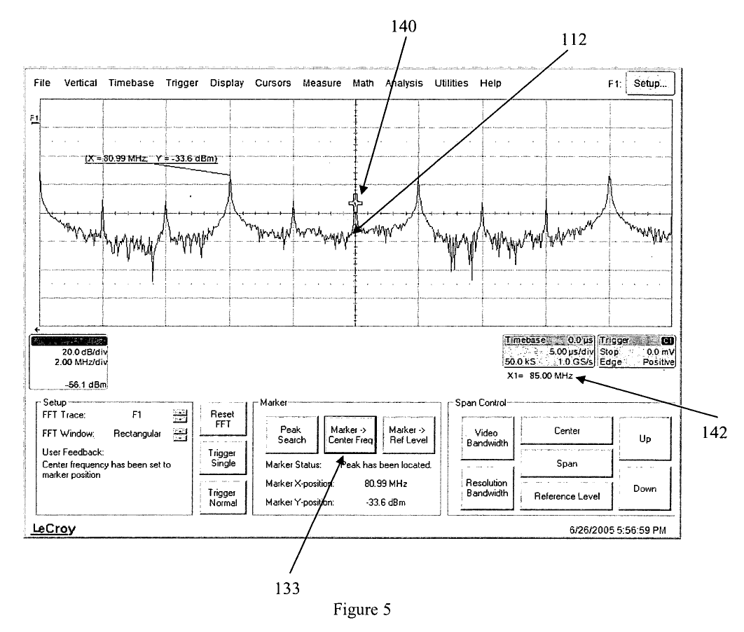

FIG. 6 is a screen shot depicting implementation of an up/down feature of the invention (in this example, horizontal center frequency positioning);

FIG. 7 is a screen shot depicting a horizontal resealing feature of the invention;

FIG. 8 is a screen shot depicting a vertical rescaling feature of the invention;

FIG. 9 is a screen shot depicting a resolution bandwidth feature of the invention used to increase frequency resolution.

FIG. 10 is a screen shot depicting waveform averaging to reduce noise in the frequency spectrum, in accordance with the invention; and

### DETAILED DESCRIPTION OF THE PREFERRED EMBODIMENTS

The invention will now be described, making reference to the accompanying drawings.

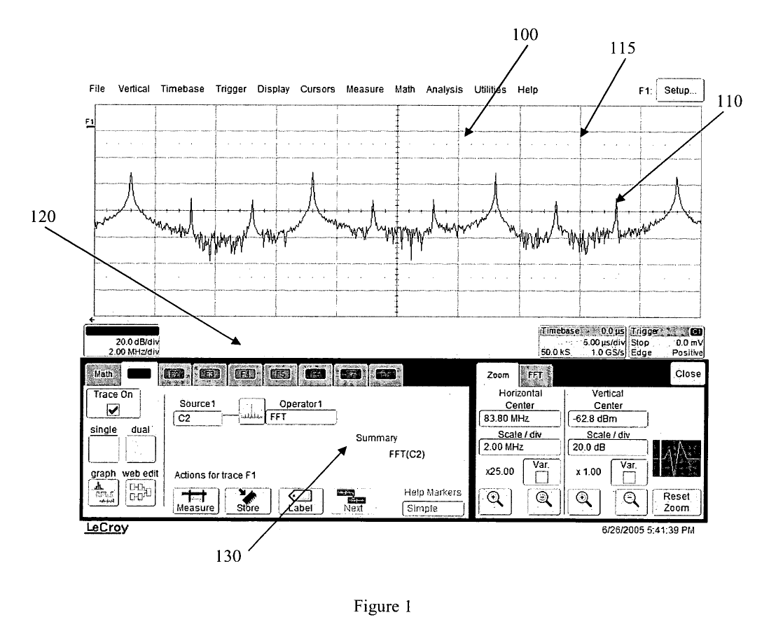

Referring first to FIG. 1, a display 100 is shown presenting a frequency domain signal 110 in a rendering portion 115 of display 100. Display 100 further comprises a main portion 120 which includes various information and settings regarding the state of the oscilloscope, and the displayed signal. A menu 130 presents various settings that are employed by a user to implement the various features of the current invention. As shown at 130, no parameters are included as the features of the invention have not yet been activated.

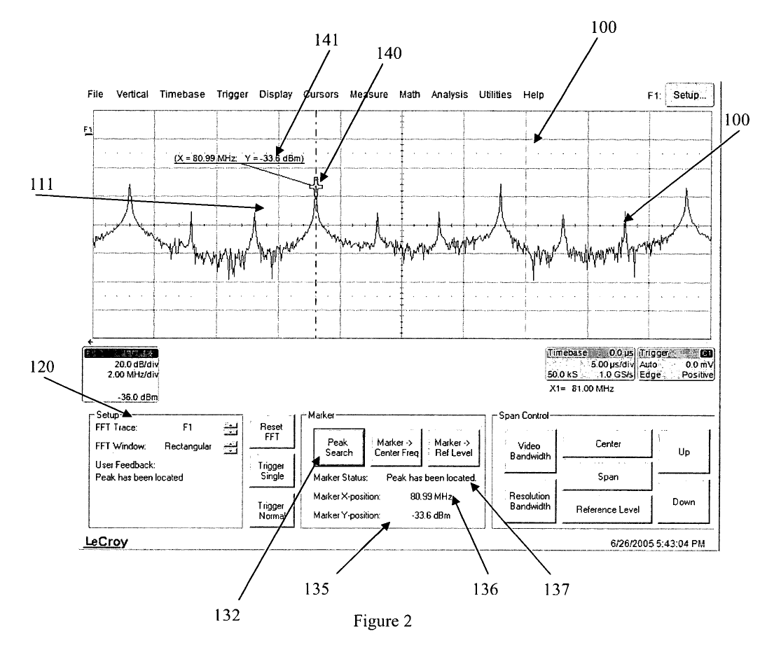

FIG. 2 depicts display 100 after a peak search function has been employed. In this particular embodiment peak search designation 132 comprises a touch screen, so that the user can implement the feature by touching the screen at the location corresponding to the peak search designation 132. Of course any other type of selection device, such as a mouse pointer or the like may be employed for not only this selection, but for all other selections in accordance with the invention. Upon implementation of the peak search function, a peak search algorithm is employed to determine the largest frequency peak in signal 110. The algorithm loops through the entire array of waveform values and selects the largest vertical value in the waveform. A cursor 140 and peak label 141 are then automatically placed corresponding to this determined peak 111, and the frequency and amplitude of the peak are measured when the peak is determined. After determination of these frequency and amplitude values, they are displayed inside the graticule at 141 along with cursor 140, and also at location 136 and 135, respectively, in menu portion 120. An indication that the marker has been placed at the detected largest frequency peak is provided at 137.

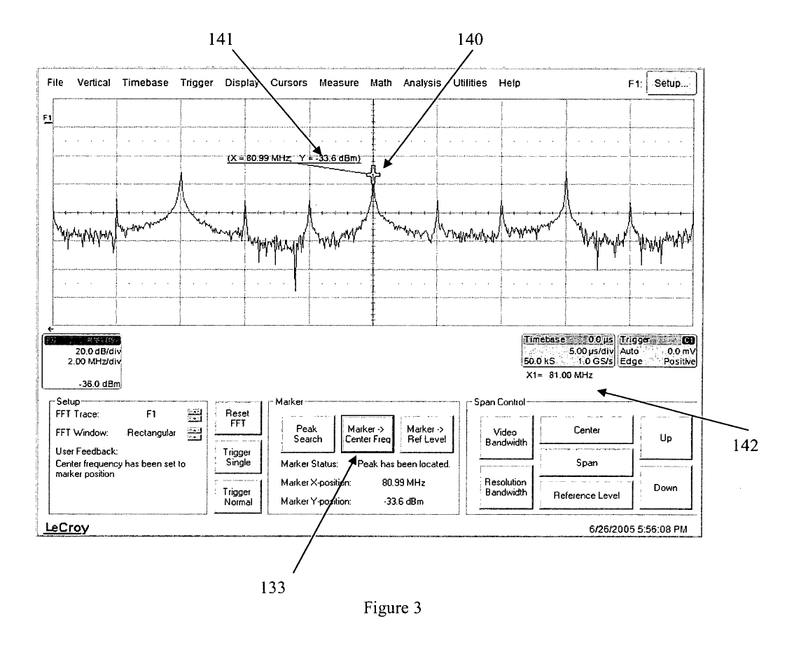

In FIG. 3, the user then selects a Marker to Center Frequency button 133. This feature of the invention repositions the frequency which is currently marked by the cursor, the detected largest frequency peak 111, to be the new center frequency on the frequency display. Thus, the user can be assured that the actual largest frequency peak is positioned at the center of the display. Because no user interpretation is required to determine the frequency value of the largest frequency peak, this frequency value is reliably repositioned to the center of the frequency display, and the frequency value corresponding to the location of the cursor is displayed at 142.

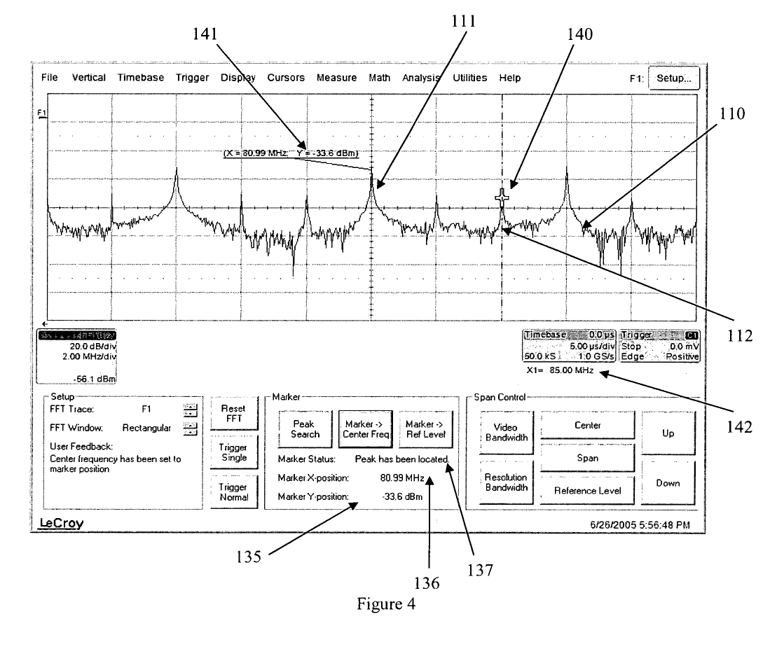

Referring next to FIG. 4, a user is able to reposition cursor 140 at any desirable frequency location 112 along signal 110. When such a repositioning is performed, the new frequency location corresponding to the cursor is noted at 142. The values 141 of the determined peak frequency 111 remain displayed on display 100, and are still noted in locations 135 and 136. Thus, while the user has moved the cursor to designate another portion of signal 111, the information regarding the determined largest frequency peak is retained. A user may then select the Marker to Center Frequency button 133 again, thus moving the cursor 140 and designated frequency location 112 to be the center frequency on display 100. The frequency of the cursor 140 is still noted at 142, and the information regarding the previously determined peak frequency 111 are still retained. Even after repositioning the frequency signal the determined peak frequency 111, and values associated therewith, are still indicated.

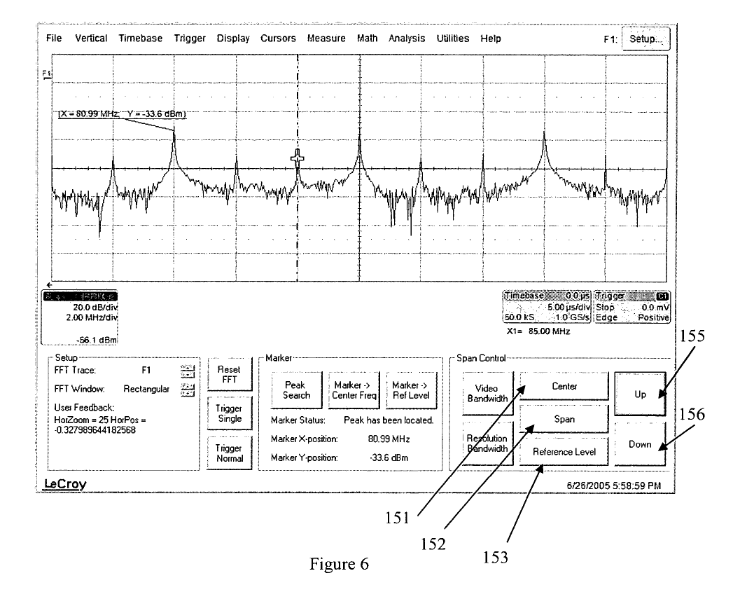

Instead of selecting a new frequency by using the cursor, in accordance with the invention, a user may also incrementally adjust the center frequency by a predetermined amount (in the depicted embodiment, looking ahead to the next FIG. 6, at 142 it can be determined that the center frequency has shifted 2 MHz to 87 MHz). By first selecting a Center button 151 (indicating that the center frequency is to be acted upon) and then selecting up or down buttons 155 or 156, the signal 110 can be shifted to the right or the left, as desired. This may be desirable when a user has designated a portion of signal 110 to be at the center of display 110, but the user was slightly inaccurate. This feature allows for incremental adjustments of the positioning of the signal so that the precise portion desired by a user may be located at the center of display 100. During these adjustments, the information relating to the previously determined peak frequency is retained.

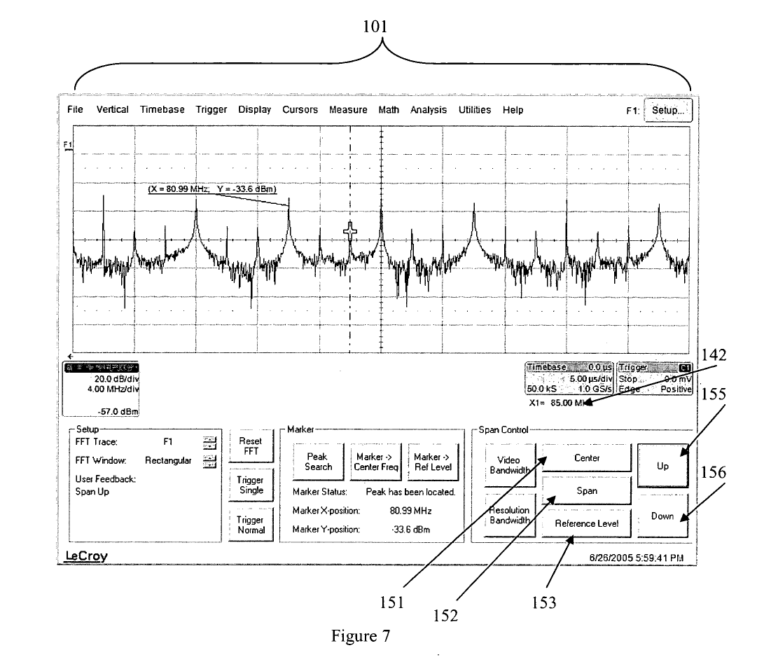

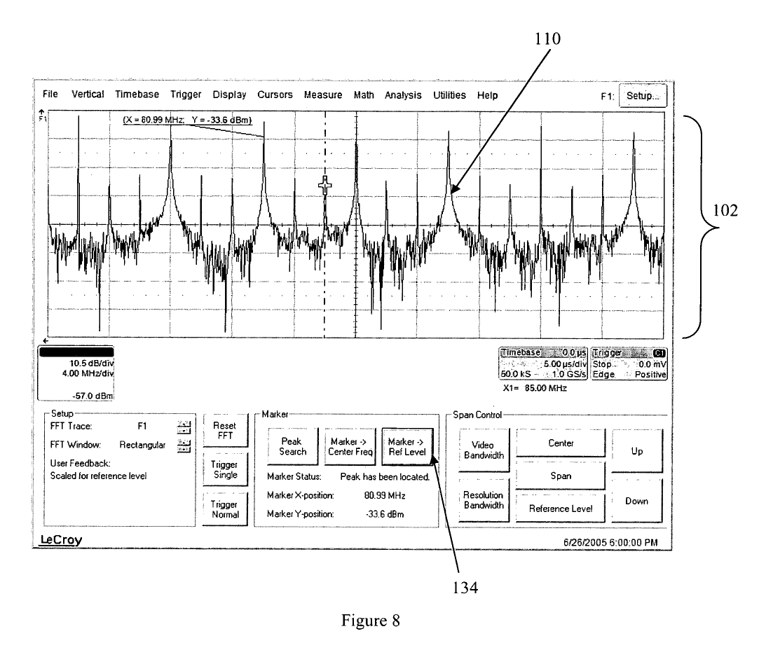

In FIG. 7, a user is able to select Span button 152, and by using up and down buttons 155 and 156 is able to incrementally rescale the width 101 of display 100. The use of the up and down buttons changes the MHz per division shown on the display (in the example embodiment from the 2.00 MHz per division of FIG. 6 to the 4.00 MHz per division of FIG. 7), thus allowing for more or less of the signal to be shown on display 100, while still maintaining the previously determined peak frequency information. If such rescaling causes any indicated frequency data to scroll off of the display, any tag previously shown in the display will still be displayed, the lead line from the lead line from the tag to point off of the screen. Similarly, in FIG. 8, the selection of a Marker to Reference Level button 134 rescales the height 102 of display 100 so that the use of the graticule is maximized, and the signal is displayed covering as much of display 100 as is practicable. Reselection of the button returns the display to its original view.

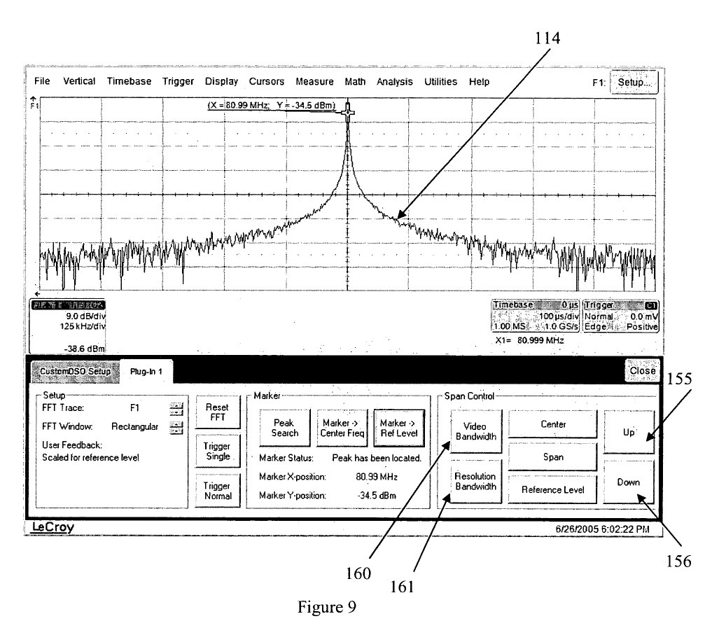

FIG. 9 depicts a user selection of a Resolution Bandwidth button, and through the use of the up and down buttons 155, 156, allows the user to incrementally change the size of the acquisition memory used to accumulate a next acquired waveform. Thus the user can increase or decrease the frequency resolution of the display of the next-acquired signal, resulting in a displayed signal with more or less calculated values per unit frequency 114. Thus, when a bandwidth increase or decrease is requested, a next, new input waveform data is acquired by the oscilloscope to generate the resultant FFT data.

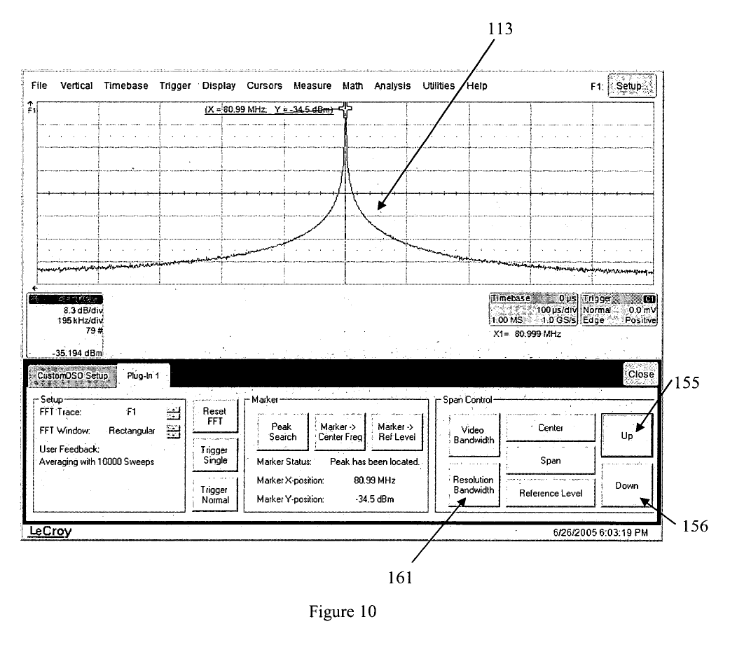

Referring next to FIG. 10, a user may select a video bandwidth button 160, and then using up and down buttons 155, 156 allows the user to incrementally designate the amount of averaging of waveforms should be performed in order to reduce noise in the displayed frequency spectrum, thus generating a smoother-looking displayed signal 113. While in FIG. 10 a different peak value is shown than that in the earlier figures, in a preferred embodiment various scaling and other manipulation of the displayed data has no bearing on the determined and labeled values, such as the detected peak frequency.

Therefore, in accordance with the invention, a user is provided with a wide array of FFT signal manipulation features that are not found on other frequency domain packages implemented on time domain analysis instruments. These features allow for a user to more precisely identify and manipulate particular portions of the FFT signal more easily than could previously be achieved.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A time domain measurement instrument, comprising:
an acquisition circuit for acquiring a signal in a time domain;
a processor for performing a Fast Fourier Transform (FFT) processing on the acquired signal to generate an FFT of the acquired signal; and
a frequency domain analysis tool for analyzing and manipulating the FFT, wherein the frequency domain analysis tool instructs the processor to automatically determine the frequency of a peak amplitude of the FFT, and to determine the amplitude at the determined peak frequency.

2. The time domain measurement instrument of claim 1, wherein the frequency domain analysis tool instructs the processor to reposition the FFT so that the determined peak frequency is set as a center frequency on a display.

3. The time domain measurement instrument of claim 1, wherein the frequency domain analysis too further receives a user input designating a selected frequency, and repositions the FFT so that the selected frequency is set as a center frequency on a display.

4. The time domain measurement instrument of claim 3, wherein information regarding the frequency and amplitude of the peak frequency is retained.

5. The time domain measurement instrument of claim 4, wherein the frequency domain analysis tool reduces noise in the frequency spectrum.

6. The time domain measurement instrument of claim 1, wherein new signal data is acquired to generate a new FFT at a different frequency resolution bandwidth.

7. The time domain measurement instrument of claim 1, wherein a vertical axis of a display of the generated FFT is rescaled.

8. A time domain measurement method, comprising the steps of:
acquiring a signal in a time domain;
performing a Fast Fourier Transform (FFT) processing on the acquired signal to generate an FFT of the acquired signal; and
analyzing and manipulating the FFT so that the frequency of a peak amplitude of the FFT is automatically determined, and so that the amplitude at the determined peak frequency is also determined.

9. The time domain measurement method of claim 8, wherein the FFT is repositioned so that the determined peak frequency is set as a center frequency on a display.

10. The time domain measurement method of claim 8, further comprising the steps of:
receiving a user input designating a selected frequency; and
repositioning the FFT so that the selected frequency is set as a center frequency on a display.

11. The time domain measurement method of claim 10, wherein information regarding the frequency and amplitude of the peak frequency is retained.

12. The time domain measurement method of claim 11, wherein noise in the frequency spectrum is reduced.

13. The time domain measurement method of claim 8, wherein new signal data is acquired to generate a new FFT at a different frequency resolution bandwidth.

14. The time domain measurement method of claim 8, wherein a vertical axis of a display of the generated FFT is rescaled.

15. A computer program for operation in accordance with a time domain measurement instrument, the computer program comprising instructions for:
acquiring a signal in a time domain;
performing a Fast Fourier Transform (FFT) processing on the acquired signal to generate an FFT of the acquired signal; and
analyzing and manipulating the FFT so that the frequency of a peak amplitude of the FFT is automatically determined, and so that the amplitude at the determined peak frequency is also determined.

16. The computer program of claim 15, wherein the FFT is repositioned so that the determined peak frequency is set as a center frequency on a display.

17. The computer program of claim 15, further comprising instruction for performing the steps of:
receiving a user input designating a selected frequency; and
repositioning the FFT so that the selected frequency is set as a center frequency on a display.

18. The computer program of claim 17, wherein information regarding the frequency and amplitude of the peak frequency is retained.

19. The computer program of claim 18, wherein noise in the frequency spectrum is reduced.

20. The computer program of claim 15, wherein new signal data is acquired to generate a new FFT at a different frequency resolution bandwidth.

21. The computer program of claim 15, wherein a vertical axis of a display of the generated FFT is rescaled.
